(19) United States
(12) Patent Application Publication
(10) Pub. No.: US 2013/0275207 A1
(43) Pub. Date: Oct. 17, 2013

(54) METHOD AND APPARATUS OF PROVIDING PICTURE RELATED INFORMATION

(71) Applicant: ALIBABA GROUP HOLDING LIMITED, Grand Cayman (KY)

(72) Inventor: Xiahong Feng, Hangzhou (CN)

(73) Assignee: Alibaba Group Holding Limited, GRand Cayman (KY)

(21) Appl. No.: 13/857,059

(22) Filed: Apr. 4, 2013

(30) Foreign Application Priority Data
Apr. 12, 2012 (CN) 201210106768.8

(51) Int. Cl. G06Q 30/02

(52) U.S. Cl. CPC G06Q 30/0244
USPC 705/14.43

(57) ABSTRACT

The present disclosure provides a method and an apparatus of providing picture related information in order to address the problem of wasting storage resources of a server under existing technologies. The server establishes a correspondence relationship between information published by a first user and a picture that is referenced when publishing the information, and upon detecting that a second user performs a specified operation on the information, the server finds the picture that has the correspondence relationship with the information, records operation information of the operation action performed by the second user and stores the recorded operation information as related information of the found picture to be provided to the first user. Through the foregoing method, the first user can select a picture to be deleted according to related information of respective pictures and delete the selected picture from a storage space provided by the server. As such, the storage space will not be greatly occupied, thus saving storage resources of the server.

### CROSS REFERENCE TO RELATED PATENT APPLICATIONS

This application claims foreign priority to Chinese Patent Application No. 201210106768.8 filed on 12 Apr. 2012, entitled “Method and Apparatus of Providing Picture Related Information,” which is hereby incorporated by reference in its entirety.

### TECHNICAL FIELD

The present disclosure relates to the field of communication technologies and in particular, relates to methods and apparatuses of providing picture related information.

### BACKGROUND

Due to the emergence of shopping websites, sellers may directly set up online stores on the shopping websites and sell commodities without inducing an expensive cost that arises from setting up physical stores. Furthermore, buyers may directly buy the commodities on the shopping websites without going outdoors, thus greatly improving the efficiency of commodity transactions.

In order to enable a seller to provide a buyer with more detailed commodity information, a server of a shopping website typically provides the seller with some storage space for storing pictures corresponding to respective commodities provided by the seller. When publishing commodity information, the seller can reference a certain picture that is stored in the storage space and publish the commodity information and the referenced pictures onto a page.

For example, if a commodity that the seller wants to sell is a one-piece dress, some photos of the one-piece dress may be taken and uploaded to the server. When commodity information of the one-piece dress is published, these pictures can be referenced and published together with the commodity information of the one-piece dress onto a corresponding page.

However, since a storage space provided to a seller by the server for storing pictures is limited, the seller needs to manage the pictures that are stored in the storage space and will need to delete some of the pictures if the storage space has been completely occupied.

Although in existing technologies, the server provides the seller with functions of adding and deleting pictures, the seller does not know which pictures in the storage space have a better advertising effect that can cause a greater increase in the sales volume of his/her commodity. A poorer picture not only fails to improve an effect of an advertisement, but may also have a negative effect on his/her commodity, affecting the sales volume and leading to a waste of advertising resources.

Continuing with the example above, if the seller references a total of three pictures that are stored in the storage space when publishing the commodity information of the one-piece dress but does not know which of these three pictures will cause a greater increase in the sales volume of the one-piece dress, the seller cannot determine which of these three pictures needs to be used and therefore needs to keep these three pictures in the storage space in all times. This will cause the storage space that is provided by the server to the seller to be in a status of high occupancy all the time and waste storage resources of the server.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

Embodiments of the present disclosure provide a method and an apparatus of providing picture related information in order to address the problem of wasting storage resources of a server under existing technologies.

An embodiment of the present disclosure provides a method of providing picture related information, which includes:

establishing and storing, by a server, a correspondence relationship between information published by a first user and a picture referenced by the first user when publishing the information;

finding, by the server, the picture that has the correspondence relationship with the information in response to detecting that a second user performs a specified operation on the information; and

recording operation information of the operation performed by the second user and storing the recorded operation information as related information of the found picture for providing to the first user.

An embodiment of the present disclosure provides an apparatus of providing picture related information, which includes:

a creation module configured to establish and store a correspondence relationship between information published by a first user and a picture referenced by the first user when publishing the information;

a detection and searching module configured to find the picture that has the correspondence relationship with the information in response to detecting that a second user performs a specified operation on the information; and

a recording and provision module configured to record operation information of the operation performed by the second user and to store the recorded operation information as related information of the found picture for providing to the first user.

The embodiments of the present disclosure provide a method and an apparatus of providing picture related information. In this method, a server establishes a correspondence relationship between information published by a first user and a picture that is referenced when publishing the information. Upon detecting that a second user performs a specified operation on the information, the server finds the picture that has the correspondence relationship with the information, records operation information of the operation action performed by the second user and stores the recorded operation information as related information of the found picture for provision to the first user. Through the foregoing method, the first user can select a picture to be deleted according to related information of respective pictures and delete the selected picture from a storage space provided by the server. As such, the storage space will not be mostly occupied, thus saving storage resources of the server.

### BRIEF DESCRIPTION OF THE DRAWINGS

FIG. 1 is a process of providing picture related information in accordance with an embodiment of the present disclosure.

FIG. 2 is a process of providing picture related information that is applied to a server of a shopping website in accordance with an embodiment of the present disclosure.

FIG. 3 is a schematic diagram illustrating a relationship between databases based upon blocks S201-S204 of FIG. 2 in accordance with an embodiment of the present disclosure.

FIG. 4 is a schematic diagram illustrating a relationship between databases based upon block S205 of FIG. 2 in accordance with an embodiment of the present disclosure.

FIG. 5 is a schematic diagram illustrating related information of a determined picture that is provided to a first user in accordance with an embodiment of the present disclosure.

FIG. 6 is a schematic diagram illustrating respective ranked pictures provided to a first user by a server in an example of ranking by the server in a descending order of sums of prices of orders in accordance with an embodiment of the present disclosure.

FIG. 7 is a structural diagram illustrating an apparatus of providing picture related information in accordance with an embodiment of the present disclosure.

FIG. 8 is a structural diagram of the example apparatus as described in FIG. 7.

### DETAILED DESCRIPTION

After detecting that a second user performs a specified operation on information published by a first user, an exemplary server records operation information of that specified operation and stores the recorded operation information as related information of a picture (that is referenced by the first user when publishing the information) for provision to the first user. As such, the first user can select a picture to be deleted based on related information of pictures that is provided by the server, and delete the selected picture from a storage space provided to the first user by the server. The storage space will not be greatly occupied, thus saving storage resources of the server.

The embodiments of the present disclosure will be described in detail hereinafter in conjunction with the accompany figures.

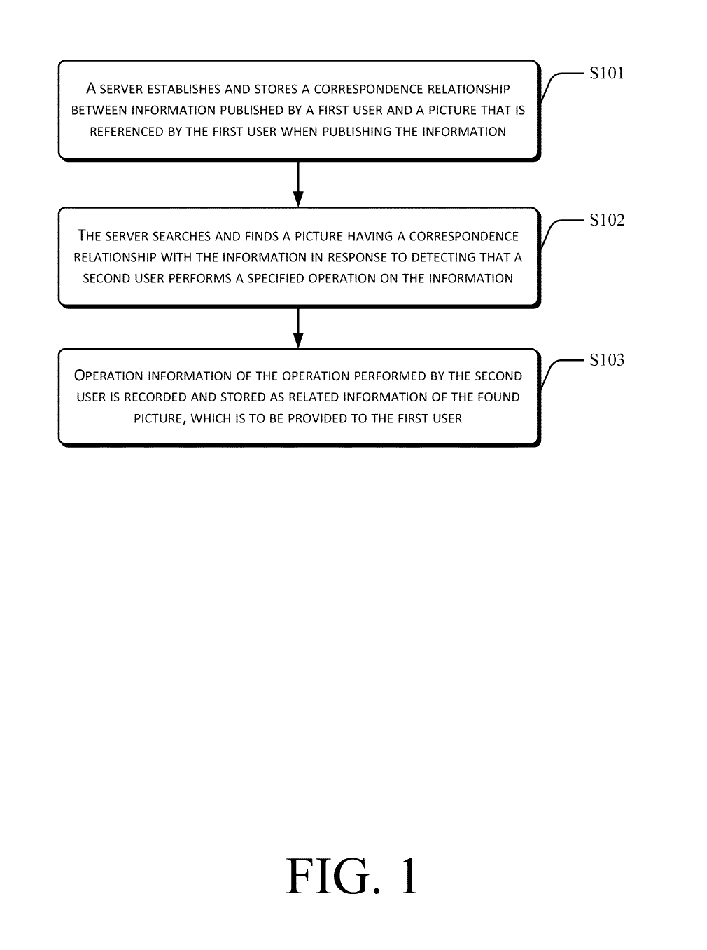

FIG. 1 is a process of providing picture related information in accordance with an embodiment of the present disclosure, the details of which include the following blocks:

S101: A server establishes and stores a correspondence relationship between information published by a first user and a picture that is referenced by the first user when publishing the information.

In this embodiment, when the first user publishes the information and references the picture when publishing the information, the server may record both an information identifier of the information that is published by the first user and a picture identifier of the picture that is referenced by the first user when publishing the information, establish and store a correspondence relationship between the recorded information identifier and the recorded picture identifier as the established correspondence relationship between the information published by the first user and the picture referenced when publishing the information. The picture that is referenced by the first user when publishing the information is stored in a storage space provided to the first user by the server. Furthermore, the first user may reference a plurality of pictures in the storage space when publishing a piece of information, and a picture in the storage space can also be referenced by multiple pieces of information.

For example, the storage space provided to the first user by the server may store three pictures—picture A, picture B and picture C. If the first user references picture A and picture B while publishing information a, the server records an information identifier of the information a and picture identifiers of picture A and picture B. If the first user references picture B and picture C when publishing information b, the server records an information identifier of the information b and picture identifiers of picture B and picture C.

Since the first user references picture A and picture B when publishing the information a, the server establishes a correspondence relationship between the information identifier of the information a and the picture identifier of picture A and establishes a correspondence relationship between the information identifier of the information a and the picture identifier of picture B, i.e., establishing correspondence relationships of the information a with picture A and picture B. Since the first user references picture B and picture C when publishing the information b, the server establishes a correspondence relationship between the information identifier of the information b and the picture identifier of picture B and establishes a correspondence relationship between the information identifier of the information b and the picture identifier of picture C, i.e., establishing correspondence relationships of the information b with picture B and picture C.

S102: The server searches and finds a picture having a correspondence relationship with the information in response to detecting that a second user performs a specified operation on the information.

In this embodiment, the server detects the information published by the first user and determines whether a second user performs a specified operation on the information published by the first user. The specified operation may be configured as according to needs. The second user refers to another user different from the first user. Upon detecting that the second user performs the specified operation on the information published by the first user, a picture corresponding to the information is searched and found based upon the correspondence relationships between the information and the pictures established at block S101.

Continuing with the example above, upon detecting that the second user performs the specified operation on the information a, the server searches for picture identifiers corresponding to the information identifier of the information a, with picture identifiers being found to be the picture identifier of picture A and the picture identifier of picture B, i.e., the pictures found to have correspondence relationships with the information a are picture A and picture B. Correspondingly, upon detecting that the second user performs the specified operation on the information b, the server searches for picture identifiers corresponding to the information identifier of the information b, with picture identifiers being found to be the picture identifier of picture B and the picture identifier of picture C, i.e., the pictures found to have correspondence relationships with the information b are picture B and picture C.

S103: Operation information of the operation performed by the second user is recorded and stored as related information of the found picture, which is to be provided to the first user.

Continuing with the example above, the server records operation information of the operation action performed by the second user on the information a, which is denoted as operation information a, and stores the operation information a as a piece of related information of picture A and also as a piece of related information of picture B. Specifically, a correspondence relationship between the operation information a and picture A, and a correspondence relationship between the operation information a and picture B are created. Thereafter, all operation information that has a correspondence relationship with picture A may be provided to the first user as related information of picture A. All operation information having a correspondence relationship with picture B may be provided to the first user as related information of picture B. Correspondingly, the server records operation information of the operation performed by the second user on the information b, which is denoted as operation information b, and stores the operation information b as a piece of related information of picture B and also as a piece of related information of picture C using the above method.

When providing related information of a picture to the first user, the server sets all recorded operation information that has a correspondence relationship with the picture as the related information of the picture for providing to the first user.

Continuing with the example above, since operation information having a correspondence relationship with picture A is the operation information a, the operation information a is provided to the first user as the related information of picture A. Since the operation information having a correspondence relationship with picture B is the operation information a and the operation information b, the operation information a and the operation information b is provided to the first user as two pieces of related information of picture B. Since the operation information having a correspondence relationship with picture C is the operation information b, the operation information b is provided to the first user as the related information of picture C.

Through the foregoing method, the server provides an accurate basis for the first user to manage the pictures stored in the storage space. Based on the related information of picture A, picture B and picture C that is respectively provided by the server, the first user can determine which picture of these three pictures need to be kept and which picture needs to be deleted, and delete a corresponding picture from the storage space, so that the storage space provided to the first user by the server will not be greatly occupied, thereby saving storage resources of the server.

In this embodiment, the specified operation performed by the second user on the information that is published by the first user may be set as a clicking operation performed by the second user on the information published by the first user. In this case, when the server detects that the second user performs a clicking operation on the information published by the first user at block S102, the server then determines that the second user performs the specified operation on the information published by the first user.

Moreover, since the specified operation (performed by the second user on the information that is published by the first user) to be detected is a clicking operation, the server may further provide a combined value of all operation information that has a correspondence relationship with the picture to the first user when the related information of the picture is provided to the first user, i.e., providing the first user with a number of all clicking operations that have a correspondence relationship with the picture. Specifically, when providing the first user with the related information of the found picture at block S103 of FIG. 1, the server determines the number of pieces of related information of the found picture that has been stored, and provides the related information of the found picture that has been stored and the determined number to the first user. Moreover, when the server establishes the correspondence relationship between the recorded operation information and the picture, a piece of operation information that has a correspondence relationship with the picture referenced by the information is generated due to a clicking operation of the second user on the information that is published by the first user. Therefore, the number of pieces of all operation information that has a correspondence relationship with the picture corresponds to the number of all clicking operations that have a correspondence relationship with the picture.

For each picture that is stored in the storage space provided to the first user, after the forgoing method provides the first user with all recorded operation information that has a correspondence relationship with the picture and the number of pieces of all operation information that has a correspondence relationship with the picture, the first user can determine which picture has a better description effect on his/her published information and which picture has a poorer description effect on his/her published information intuitively based on a respective number of pieces of operation information that has a correspondence relationship with each picture.

Continuing with the example above, if a second user performs a clicking operation on the information a that is published by the first user, picture A corresponds to one piece of operation information a and picture B corresponds to one piece of operation information a. If two second users perform clicking operations on the information b that is published by the first user, picture B corresponds to two pieces of operation information b and picture C corresponds to two pieces of operation information b. Thus, the number of pieces of all operation information having a correspondence relationship with picture A is one (one piece of operation information a). The number of pieces of all operation information having a correspondence relationship with picture B is three (one piece of operation information a and two pieces of operation information b). The number of pieces of all operation information having a correspondence relationship with picture C is two (two pieces of operation information b). Based on respective numbers of pieces of operation information having a correspondence relationship with each picture, the first user can intuitively determine that picture B has a better description effect on his published information and the picture A has a poorer description effect on his published information. The picture A may therefore be deleted.

In this embodiment, when the method as illustrated in FIG. 1 is applied to a server of a shopping website, the first user is a first user acting as a seller, and the second user is a second user acting as a buyer. At this time, if information published by the first user who acts as a seller is commodity information, a method that the server establishes a correspondence relationship between the information published by the first user and a picture referenced when publishing the information may include: recording a commodity identifier of the commodity information published by the first user and a picture identifier of the picture referenced by the first user when publishing the commodity information, and establishing a correspondence relationship between the recorded commodity identity and the recorded picture identifier, where the commodity identifier may include a commodity identity (ID). For example, the recorded picture identifier of the picture that is referenced by the first user when publishing the commodity information may also be a picture ID.

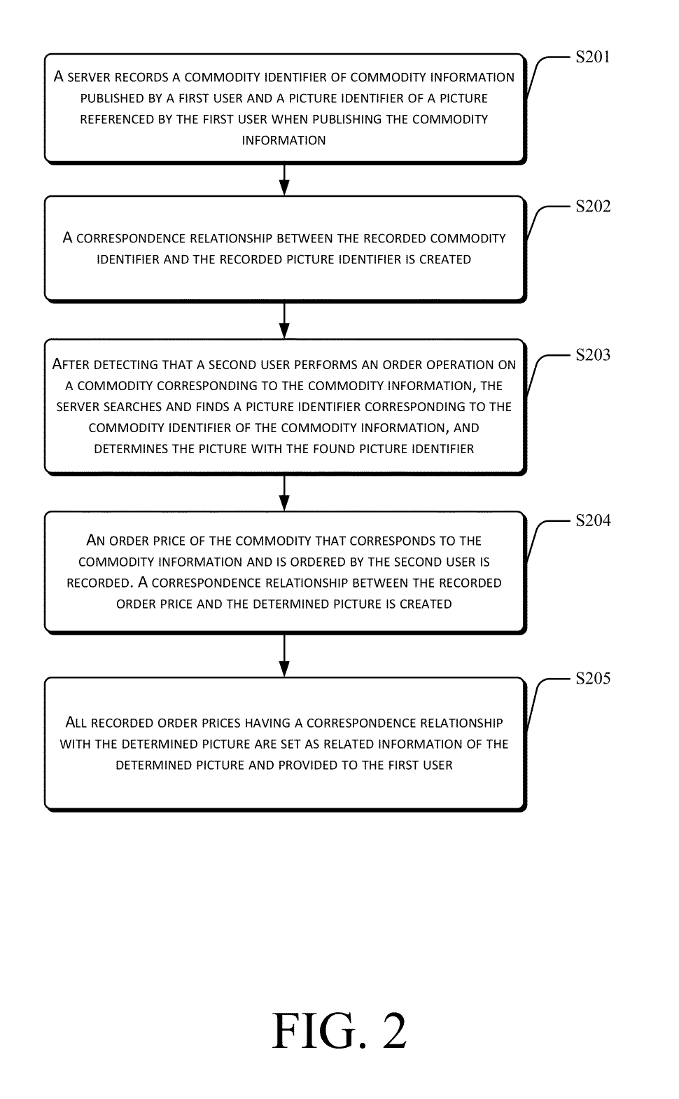

At this time, the specified operation at block S102 may be set as an order operation performed by the second user on a commodity corresponding to the commodity information. In other words, the server determines that the second user performs the specified operation on the commodity information published by the first user in response to detecting that the second user performs an order operation on the commodity corresponding to the commodity information. Correspondingly, the server records operation information of this operation that is performed by the second user, which may include: recording an order price of the commodity that corresponds to the commodity information and is ordered by the second user as recorded operation information of the operation performed by the second user. Details of a process of application of the method as shown in FIG. 1 to a server of a shopping website are shown in FIG. 2.

FIG. 2 is a process of providing picture related information that is applied to a server of a shopping website in accordance with an embodiment of the present disclosure, the details of which include the following blocks:

S201: The server records a commodity identifier of commodity information published by a first user and a picture identifier of a picture referenced by the first user when publishing the commodity information.

S202: A correspondence relationship between the recorded commodity identifier and the recorded picture identifier is created.

S203: After detecting that a second user performs an order operation on a commodity corresponding to the commodity information, the server searches and finds a picture identifier corresponding to the commodity identifier of the commodity information, and determines the picture with the found picture identifier.

S204: An order price of the commodity that corresponds to the commodity information and is ordered by the second user is recorded. A correspondence relationship between the recorded order price and the determined picture is created.

When the second user who acts as a buyer performs an order operation on a commodity corresponding to certain commodity information at the server of the shopping website, the server will generate a purchase order which records an order price of the commodity that is ordered by the second user.

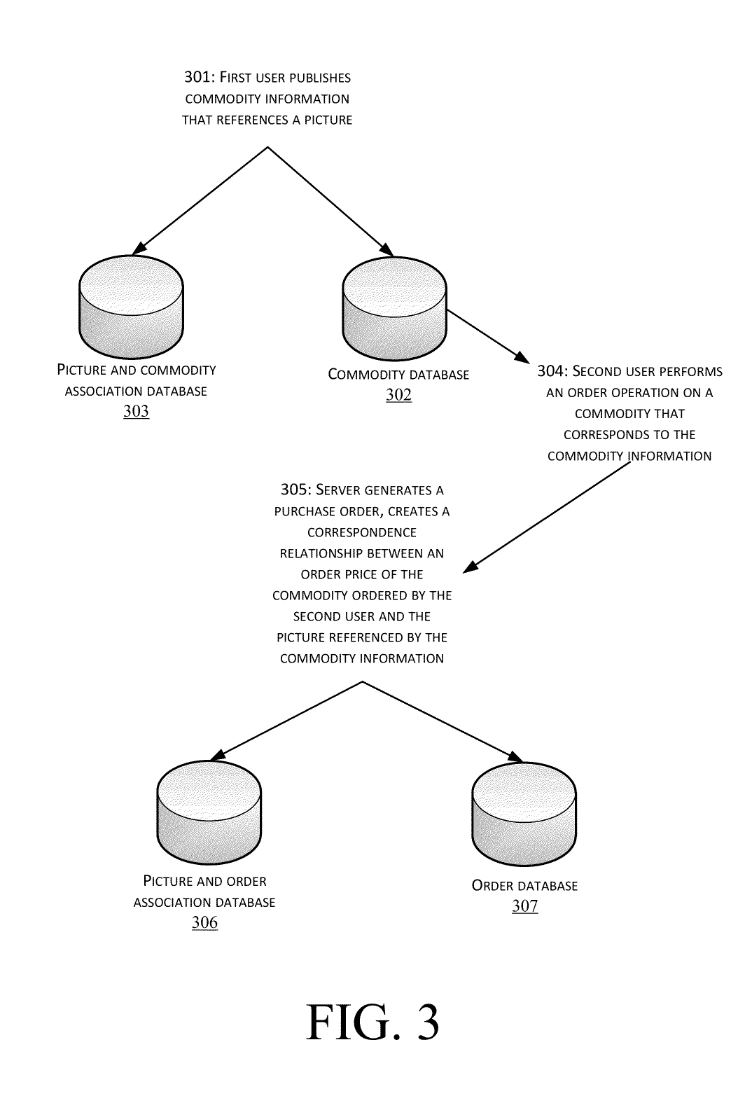

The foregoing blocks S210-S204 may be considered as a data collection process of the server. Relationships among respective databases that are related to the data collection process are shown in FIG. 3.

FIG. 3 is a schematic diagram illustrating relationships among databases at blocks S201-S204 of FIG. 2 in accordance with an embodiment of the present disclosure. In FIG. 3, the first user publishes 301 commodity information that references a picture. A commodity identifier corresponding to the commodity information is stored in a commodity database 302. A correspondence relationship, which is created by the server, between the commodity identifier and a picture identifier of the picture referenced by the commodity information is stored in a picture and commodity association database 303. When the second user performs 304 an order operation on a commodity corresponding to the commodity information, the server will create 305 a correspondence relationship between an order price of the commodity that is ordered by the second user and the picture that is referenced by the commodity information through a generated purchase order, store the correspondence relationship in the picture and order association database 306, and store the generated order in an order database 307.

S205: All recorded order prices having a correspondence relationship with the determined picture are set as related information of the determined picture and provided to the first user.

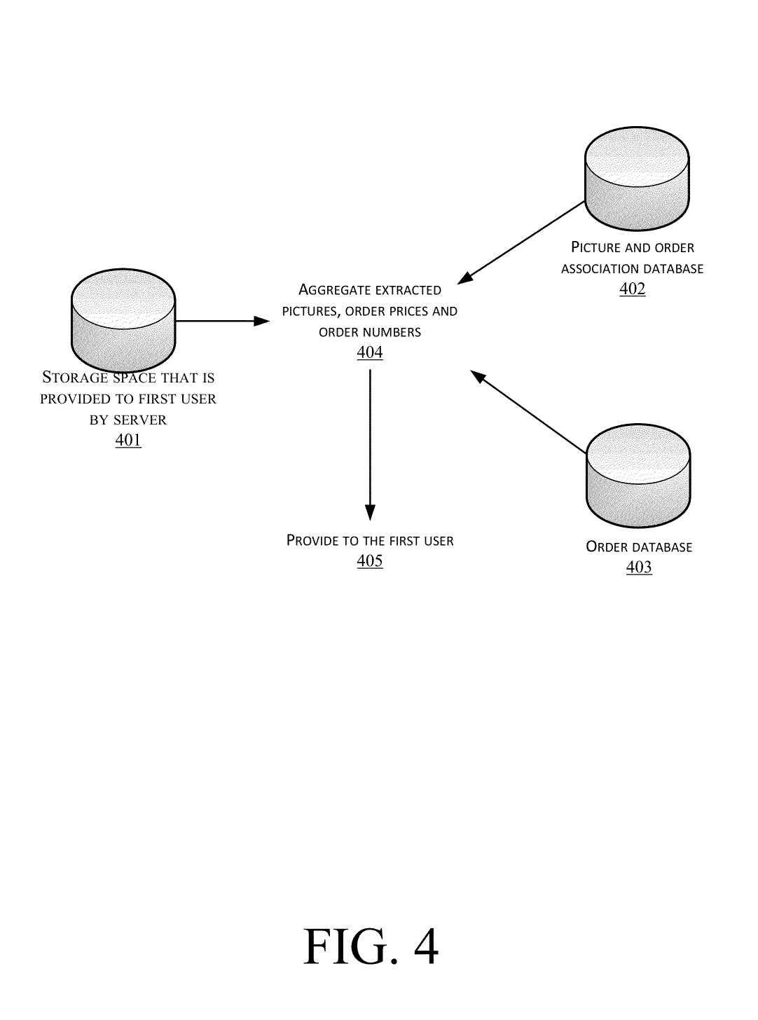

Since an order operation of each second user will generate a purchase order, the server may further provide the first user with order numbers to which all order prices that have correspondence relationships with the determine picture belong. At that time, block S205 of FIG. 2 may act as a process in which the server presents the related information of the picture to the first user. Relationships among databases that are related to this process are shown in FIG. 4.

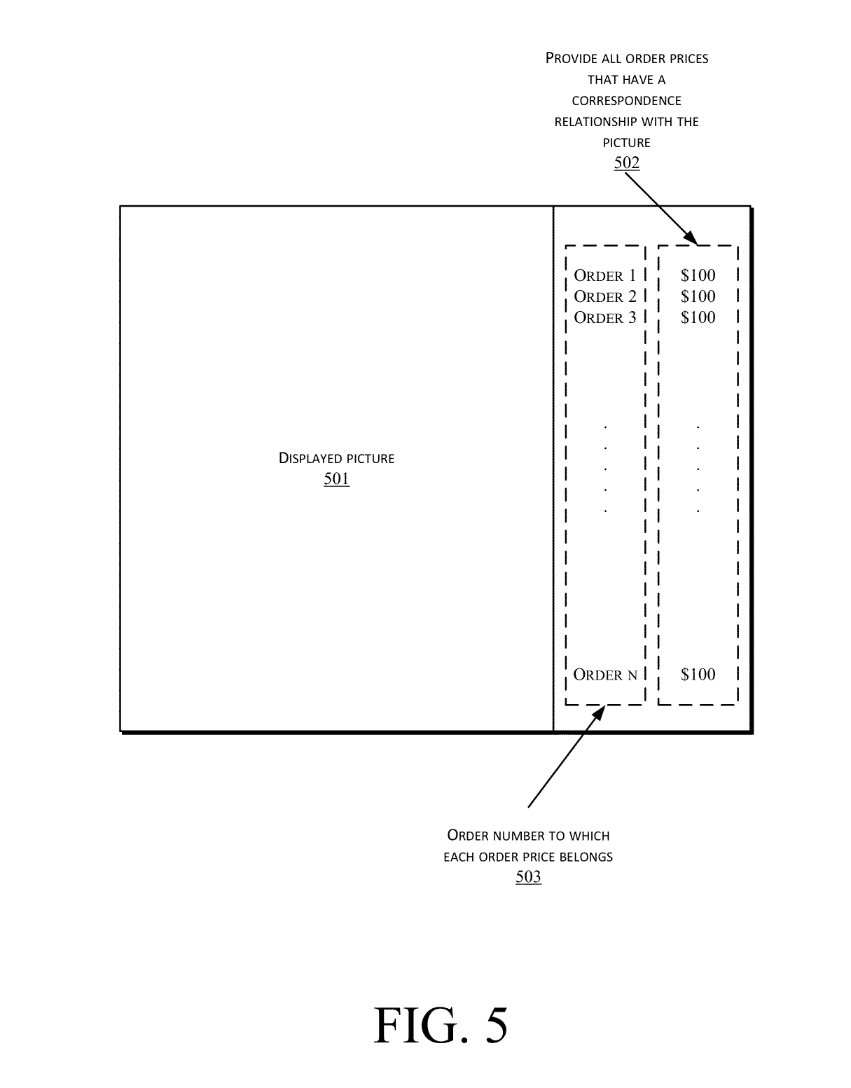

FIG. 4 is a schematic diagram illustrating relationships among databases at block S205 of FIG. 2 in accordance with an embodiment of the present disclosure. In FIG. 4, the server extracts respective pictures from the storage space 401 that is provided to the first user, extracts order prices that have correspondence relationships with the respective pictures from the picture and order association database 402, extracts order numbers to which the order prices belong from the order database 403, aggregates 404 the extracted pictures, order prices and order numbers, and finally provides 405 thereof to the first user, as illustrated in FIG. 5.

FIG. 5 is a schematic diagram illustrating related information of the determined picture that is provided to the first user in accordance with an embodiment of the present disclosure. As shown in FIG. 5, the server presents the displayed picture 501 to the first user, and provides all recorded order prices 502 having a correspondence relationship with the determined picture and respective order numbers 503 to which the order prices belong to the first user. FIG. 5 uses all recorded order prices having correspondence relationships with the determined picture to be $100 and respective order numbers to which the order prices belong to be Order 1 to Order n, as an example for illustration.

In order to further provide the first user with an accurate criterion of picture management and thus further save a storage resource of the server, at block S205, the server may further accumulate all recorded order prices that are set as related information of the picture to obtain a sum of the order prices, and provide the related information of the picture that has been stored and the sum of order prices that has been obtained to the first user. Specifically, the server can accumulate all recorded order prices that have correspondence relationships with the picture to obtain a sum of the order prices, and provide all the recorded order prices that have correspondence relationships with the determined picture and the obtained sum of the order prices to the first user. The first user may intuitively determine which picture may improve the sales volume of his/her commodity to a greater amount and which picture may improve the sales volume of his/her commodity to a lesser amount based on respective sums of order prices of the pictures.

Furthermore, when presenting pictures of the first user to the first user, the server may further extract the pictures stored in the storage space that is provided to the first user, and rank and present the extracted pictures based on respective sums of order prices obtained for the extracted pictures and according to a preset ranking rule. The ranking rule may be set as needed. For example, a ranking order according to a descending order of the sums of order prices, or according to an ascending order of the sums of order prices, etc., may be set.

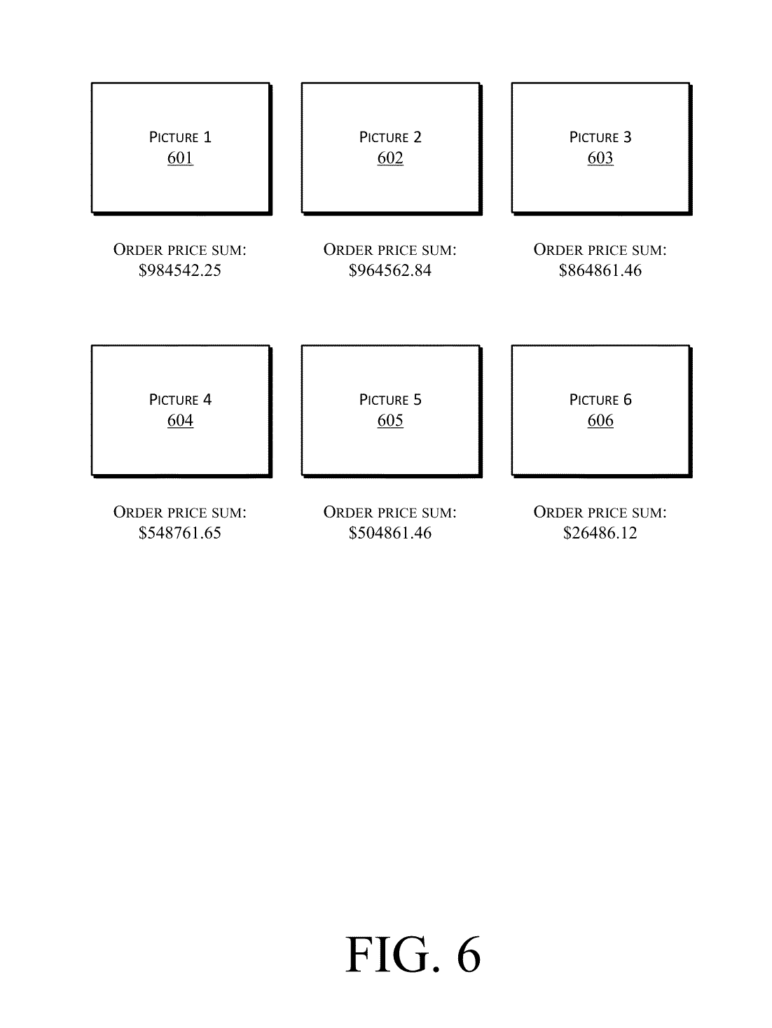

FIG. 6 is a schematic diagram illustrating ranked pictures that are presented by the server to the first user using an example of an order ranked by the server according to a descending order of sums of orders prices in accordance with an embodiment of the present disclosure. In FIG. 6, the storage space that is provided to the first user stores a total of six pictures 601-606, i.e., pictures 1-6. These six pictures are ranked in a descending order of respective sums of order prices and are presented to the first user. Based on the ranking order, the first user may intuitively delete a number of pictures that are positioned at the end of the ranking order to save the storage resources of the server.

Based upon an idea similar to the foregoing, the server may further determine the number of all recorded order prices that have correspondence relationships with the picture, and provide all recorded order prices that have correspondence relationships with the picture, the determined sum of the order prices and the determined number of the order prices to the first user. Details thereof will be repeatedly described herein.

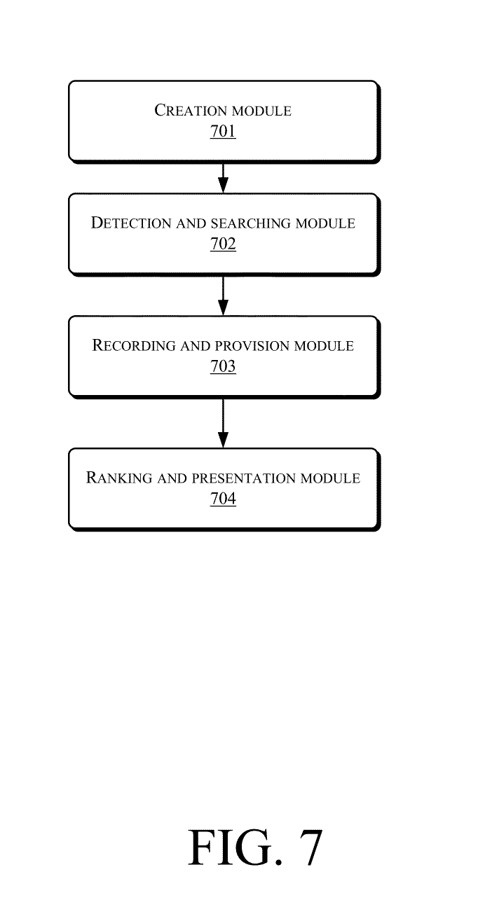

FIG. 7 is a structural diagram of an apparatus of providing picture related information in accordance with an embodiment of the present disclosure, the details thereof include:

a creation module 701 configured to establish and store a correspondence relationship between information published by a first user and a picture referenced by the first user when publishing the information;

a detection and searching module 702 configured to find the picture that has the correspondence relationship with the information in response to detecting that a second user performs a specified operation on the information; and

a recording and provision module 703 configured to record operation information of the operation performed by the second user and to store the recorded operation information as related information of the found picture to be provided to the first user.

The detection and searching module 702 may further be configured to determine that the second performs the specified operation on the information in response to detecting that the second user performs a clicking operation on the information.

The recording and provision module 703 may further be configured to determine a number of pieces of related information of the found picture that is stored and to provide the first user with the related information of the found picture that is stored and the determined number.

The detection and searching module 702 may further be configured to determine, when the information published by the first user is commodity information, that the second user performs the specified operation on the commodity information in response to detecting that the second user performs an order operation on a commodity corresponding to the commodity information.

The recording and provision module 703 may further be configured to record an order price of the commodity that corresponds to the commodity information and is ordered by the second user as the recorded operation information of the operation performed by the second user.

The recording and provision module 703 may further be configured to accumulate all recorded order prices that are set as the related information of the found picture to obtain a sum of the order prices, and to provide the related information of the found picture that is stored and the sum of the order prices that is obtained to the first user.

The apparatus further includes:

a ranking and presentation module 704 configured to extract, when presenting pictures of the first user, the pictures stored in a storage space that is provided to the first user, and to rank and present the extracted pictures based on respective sums of order prices obtained for the extracted pictures and according to a preset ranking rule.

The embodiments of the present disclosure provide a method and an apparatus of providing picture related information. In this method, a server establishes a correspondence relationship between information published by a first user and a picture that is referenced when publishing the information, and upon detecting that a second user performs a specified operation on the information, the server finds the picture that has the correspondence relationship with the information, records operation information of the operation action performed by the second user and stores the recorded operation information as related information of the found picture to be provided to the first user. Through the foregoing method, the first user can select a picture to be deleted according to related information of respective pictures and delete the selected picture from a storage space provided by the server. As such, the storage space will not be greatly occupied, thus saving storage resources of the server.

A technical person skilled in the art should understand that the embodiments of the present disclosure may be implemented as methods, systems, or products of computer software. Therefore, the present disclosure may be implemented in forms of hardware, software, or a combination of hardware and software. Further, the present disclosure may be implemented in the form of products of computer software executable on one or more computer readable storage media (including but not limited to disk storage device, CD-ROM, optical storage device, etc.) that include computer readable program instructions.

The present disclosure is described in accordance with flowcharts and/or block diagrams of the exemplary methods, apparatuses (devices) and computer program products. It should be understood that each process and/or block and combinations of the processes and/or blocks of the flowcharts and/or the block diagrams may be implemented in the form of computer program instructions. Such computer program instructions may be provided to a general purpose computer, a special purpose computer, an embedded processor or another processing apparatus having a programmable data processing device to generate a machine, so that an apparatus having the functions indicated in one or more blocks described in one or more processes of the flowcharts and/or one or more blocks of the block diagrams may be implemented by executing the instructions by the computer or the other processing apparatus having programmable data processing device.

Such computer program instructions may also be stored in a computer readable memory device which may cause a computer or another programmable data processing apparatus to function in a specific manner, so that a manufacture including an instruction apparatus may be built based on the instructions stored in the computer readable memory device. That instruction device implements functions indicated by one or more processes of the flowcharts and/or one or more blocks of the block diagrams.

The computer program instructions may also be loaded into a computer or another programmable data processing apparatus, so that a series of operations may be executed by the computer or the other data processing apparatus to generate computer implemented processing. Therefore, the instructions executed by the computer or the other programmable apparatus may be used to implement one or more processes of the flowcharts and/or one or more blocks of the block diagrams.

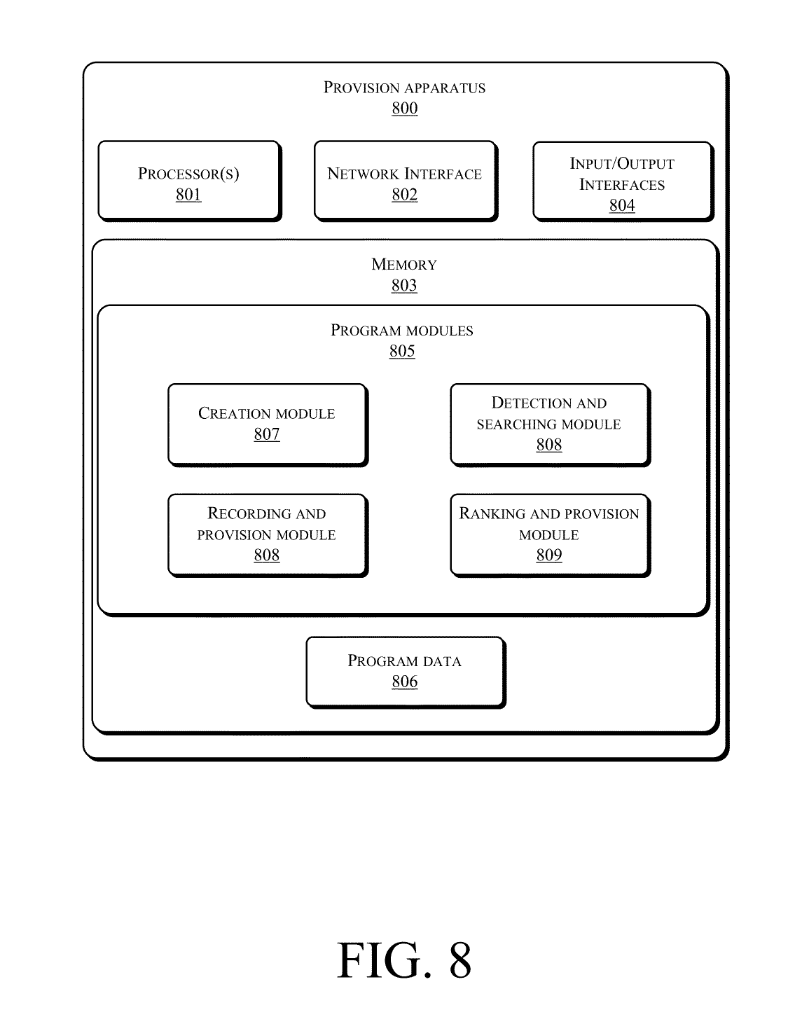

For example, FIG. 8 illustrates an example provision apparatus 800, such as the apparatus as described above, in more detail. In one embodiment, the apparatus 800 can include, but is not limited to, one or more processors 801, a network interface 802, memory 803, and an input/output interface 804.

The memory 803 may include computer-readable media in the form of volatile memory, such as random-access memory (RAM) and/or non-volatile memory, such as read only memory (ROM) or flash RAM. The memory 803 is an example of computer-readable media.

Computer-readable media includes volatile and non-volatile, removable and non-removable media implemented in any method or technology for storage of information such as computer readable instructions, data structures, program modules, or other data. Examples of computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer-readable media does not include transitory media such as modulated data signals and carrier waves.

The memory 803 may include program modules 805 and program data 806. In one embodiment, the program modules 805 may include a creation module 807, a detection and searching module 808, a recording and provision module 809 and a ranking and presentation module 810. Details about these program modules thereof may be found in the foregoing embodiments described above.

A technical person skilled in the art may make changes and modifications of the present application without departing from the spirit and scope of the present disclosure. If these changes and modifications are within the scope of the claims and their equivalents of the present disclosure, the present disclosure intends to covers such changes and modifications.

What is claimed is:

1. A method of providing picture related information, comprising:
establishing and storing, by a server, a correspondence relationship between information published and a picture referenced when publishing the information by a first user;
finding, by the server, the picture that has the correspondence relationship with the information in response to detecting that a second user performs a specified operation on the information; and
recording operation information of the specified operation performed by the second user and storing the recorded operation information as related information of the found picture.

2. The method as recited in claim 1, further comprising providing the related information of the found picture to the first user.

3. The method as recited in claim 2, wherein detecting that the second user performs the specified operation on the information comprises:
detecting that the second user performs a clicking operation on the specified information; and
providing the related information of the found picture to the first user comprising:
determining a number of pieces of related information of the found picture that is stored, and
providing the related information of the found picture that is stored and the determined number.

4. The method as recited in claim 1, wherein the information published by the first user comprises commodity information, and detecting that the second user performs the specified operation on the information comprises:
detecting that the second user performs an order operation on a commodity corresponding to the commodity information.

5. The method as recited in claim 4, wherein recording the operation information of the operation performed by the second user comprises recording an order price of the commodity corresponding to the commodity information that is ordered by the second user as the recorded operation information of the operation performed by the second user.

6. The method as recited in claim 4, wherein providing the related information of the found picture to the first user comprises:
accumulating recorded order prices that are set as the related information of the found picture to obtain a sum of the order prices; and
providing the related information of the found picture that is stored and the sum of the order prices that is obtained.

7. The method as recited claim 6, further comprising:
extracting, by the server, stored pictures from a storage space that is provided to the first user;
ranking the extracted pictures according to a preset ranking rule and based on respective sums of order prices obtained for the extracted pictures; and
presenting the ranked pictures to the first user.

8. An apparatus of providing picture related information, comprising:
a creation module configured to establish and store a correspondence relationship between information published and a picture referenced when publishing the information by a first user;
a detection and searching module configured to find the picture that has the correspondence relationship with the information in response to detecting that a second user performs a specified operation on the information; and
a recording and provision module configured to record operation information of the operation performed by the second user and to store the recorded operation information as related information of the found picture to be provided to the first user.

9. The apparatus as recited in claim 8, wherein:
the detection and searching module is further configured to determine that the second user performs the specified operation on the information in response to detecting that the second user performs a clicking operation on the information; and
the recording and provision module is further configured to determine a number of pieces of related information of the found picture that is stored and to provide the first user with the related information of the found picture that is stored and the determined number.

10. The apparatus as recited in claim 8, wherein:
the detection and searching module is further configured to determine, when the information published by the first user is commodity information, that the second user performs the specified operation on the commodity information in response to detecting that the second user performs an order operation on a commodity corresponding to the commodity information; and
the recording and provision module is further configured to record an order price of the commodity corresponding to the commodity information that is ordered by the second user as the recorded operation information of the operation performed by the second user.

11. The apparatus as recited in claim 10, wherein the recording and provision module is further configured to accumulate all recorded order prices that are set as the related information of the found picture to obtain a sum of the order prices.

12. The apparatus as recited in claim 11, wherein the recording and provision module is further configured to provide the related information of the found picture that is stored and the sum of the order prices that is obtained to the first user.

13. The apparatus as recited in claim 12, wherein the apparatus further includes:
a ranking and presentation module configured to extract, when presenting pictures of the first user, the pictures stored in a storage space that is provided to the first user, and to rank and present the extracted pictures based on respective sums of order prices obtained for the extracted pictures and according to a preset ranking rule.

14. One or more computer-readable media storing executable instructions that, when executed by one or more processors, cause the one or more processors to perform acts comprising:
establishing and storing, by a server, a correspondence relationship between information published and a picture referenced when publishing the information by a first user;
finding, by the server, the picture that has the correspondence relationship with the information in response to detecting that a second user performs a specified operation on the information; and
recording operation information of the operation performed by the second user and storing the recorded operation information as related information of the found picture.

15. The one or more computer-readable media as recited in claim 14, the acts further comprising providing the related information of the found picture to the first user.

16. The one or more computer-readable media as recited in claim 15, wherein detecting that the second user performs the specified operation on the information comprises:
detecting that the second user performs a clicking operation on the information; and
providing the related information of the found picture to the first user comprising:
determining a number of pieces of related information of the found picture that is stored, and
providing the related information of the found picture that is stored and the determined number.

17. The one or more computer-readable media as recited in claim 15, wherein the information published by the first user comprises commodity information, and detecting that the second user performs the specified operation on the information comprises:
detecting that the second user performs an order operation on a commodity corresponding to the commodity information.

18. The one or more computer-readable media as recited in claim 17, wherein recording the operation information of the operation performed by the second user comprises recording an order price of the commodity corresponding to the commodity information that is ordered by the second user as the recorded operation information of the operation performed by the second user.

19. The one or more computer-readable media as recited in claim 17, wherein providing the related information of the found picture to the first user comprises:
accumulating recorded order prices that are set as the related information of the found picture to obtain a sum of the order prices; and
providing the related information of the found picture that is stored and the sum of the order prices that is obtained.

20. The one or more computer-readable media as recited claim 19, the acts further comprising:
extracting, by the server, stored pictures from a storage space that is provided to the first user;
ranking the extracted pictures according to a preset ranking rule and based on respective sums of order prices obtained for the extracted pictures; and
presenting the ranked pictures to the first user.
